(19) United States
(12) Patent Application Publication
(10) Pub. No.: US 2012/0147045 A1
(43) Pub. Date: Jun. 14, 2012

(54) IMAGE DISPLAY APPARATUS, IMAGE DISPLAY METHOD, AND IMAGE DISPLAY PROGRAM

(75) Inventors: Hiroshi OIKE, Wakayama-shi (JP); Hiroaki Sakaguchi, Wakayama-shi (JP); Yuichi Oda, Wakayama-shi (JP); Tomoo Nakano, Wakayama-shi (JP); Yasushi Usami, Wakayama-shi (JP)

(73) Assignee: NK WORKS CO., LTD., Wakayama-shi (JP)

(21) Appl. No.: 13/324,044

(22) Filed: Dec. 13, 2011

(30) Foreign Application Priority Data
Dec. 14, 2010 (JP) 2010-278518

(51) Int. Cl. G09G 5/00

(52) U.S. Cl. 345/634

(57) ABSTRACT

An image display apparatus including a first storage means for storing at least one item of image data, correction condition data for correcting the image data, and corrected image data obtained after the image data is corrected on the basis of the correction condition data; an image processing means for producing the corrected image data; a display means comprising a screen for superimposing an original image based on the image data and a corrected image based on the corrected image data onto each other and displaying either the original image or the corrected image; an input means for selecting an image to be displayed on the display screen, and a display control means for switching between the images in response to an input from the input means, so that either the original image or the corrected image is displayed on the display screen.

### TECHNICAL FIELD

The present invention relates to an image display apparatus, an image display method, and an image display program.

### BACKGROUND ART

In a digital camera, such as those taught in Patent Literature 1, captured images can be viewed on a liquid crystal display provided at the back of the camera. When an image is captured, the captured image data is corrected on the basis of a selected image-capturing mode from a plurality of modes, and a corrected image based on the image data after correction can be displayed on the liquid crystal display. Examples of image-capturing modes include a night scene mode suitable for photographing night scenes, a dish mode suitable for photographing food, and the like. On the basis of the selected image-capturing mode, correction parameters are applied to correct the image data.

### CITATION LIST

### Patent Literature

PTL 1: Japanese Unexamined Patent Publication No. 2006-191232

### DISCLOSURE OF THE INVENTION

### Problems to Be Solved by the Invention

In an ordinary digital camera, only a corrected image appears on the liquid crystal display. Therefore, the degree to which the original image data has been corrected cannot be known. Specifically, the effect of the correction based on each image-capturing mode could not be identified.

Such a problem occurs not only in digital cameras, but also in cellular phones and smartphones, which display captured images, as well as in any general image display apparatus, which displays stored image data on a screen. The present invention has been accomplished to solve such a problem. An object of the present invention is to provide an image display apparatus, an image display method, and an image display program, each of which enables a user to easily confirm the degree to which original image data has been corrected.

### Means for Solving the Problems

An image display apparatus according to a first aspect of the present invention comprises:

a first storage means for storing at least one item of image data, correction condition data for correcting the image data, and corrected image data obtained after the image data is corrected on the basis of the correction condition data;

an image processing means for producing the corrected image data by correcting the image data on the basis of the correction condition data;

a display means comprising a screen for superimposing an original image based on the image data and a corrected image based on the corrected image data onto each other and displaying either the original image or the corrected image;

an input means for selecting an image to be displayed on the display screen; and

a display control means for switching between the images in response to an input from the input means, so that either the original image or the corrected image is displayed on the display screen.

According to the above-described configuration, the first storage means stores image data, correction condition data for correcting the image data, and corrected image data obtained after the image data is corrected on the basis of the correction condition data. Further, an original image based on the image data and a corrected image based on the corrected image data are superimposed onto each other, and either of the images is displayed on the screen. In response to an input from the input means, the original image and the corrected image are switched therebetween, so that one of these images is displayed on the screen. As such, since the original image and the corrected image are switched therebetween upon receiving an input from the input means, a user can easily visually confirm the effect of the correction. In particular, because the original image and the corrected image are superimposed onto each other, a user can easily distinguish a difference between the images.

The above-described image display apparatus may further comprise:

an image-capturing means for producing the image data;

a setting means for selecting one correction condition from a plurality of correction conditions before the image-capturing means captures an image and specifying the correction condition data associated with the correction condition; and

a storage control means for storing in the first storage means the image data produced by the image-capturing means, the specified correction condition data, and the corrected image data produced by the image processing means.

According to this configuration, the above-described image display apparatus can be used as a device, such as a camera equipped with an image-capturing means. The image data produced by the image-capturing means is corrected by the correction condition data, which is based on the pre-selected correction condition, and stored in the first storage means with the image data and the correction condition data. Thereafter, the stored data can be used to be displayed on the screen.

The image display apparatus may further comprise a nonvolatile second storage means for storing the corrected image data. The storage control means allows the second storage means to store the corrected image data produced by the image processing means. As described above, the image data, etc., stored in the first storage means can be used to be viewed on a screen; in addition to this, the corrected image data stored in the second storage means can be used for storage. In particular, large-volume image data can be stored in the second storage means.

The input means may take various forms, such as a button or a lever. The input means may be, for example, a touch switch provided with the screen. In this manner, a user can touch a former or latter image displayed at an end portion of the screen, allowing one of these images to appear in the middle of the screen as a selected image. Examples of a touching operation include a so-called tapping operation, flicking operation, dragging operation, and the like. These operations can switch between an original image and a corrected image to be displayed on a screen.

The display control means may display an indication specifying an image before correction when an original image appears on the screen, and display an indication specifying an image after correction when a corrected image appears on the display screen. This clarifies which image is before or after the correction, enabling a user to more effectively confirm the effects of the correction. The indication that specifies the image before correction may be, for example, but not limited to, “before” or “before correction,” and the indication that specifies the image after correction may be, for example, but not limited to, “after” or “after correction.”

A second aspect of the present invention is a method for displaying an image using an image display apparatus including a screen for displaying an image and an input means for selecting an image to be displayed on the display screen, the method comprising:

an image-processing step of producing corrected image data by correcting image data on the basis of correction condition data;

a displaying step of superimposing an original image based on the image data and a corrected image based on the corrected image data onto each other and displaying either the original image or the corrected image on the display screen; and

a switching step of switching between the images in response to an input from the input means, so that either the original image or the corrected image is displayed on the display screen.

An image display program according to a third aspect of the present invention causes a computer within an image display apparatus including a display screen for displaying an image and an input means for selecting an image to be displayed on the display screen, to execute:

an image-processing step of producing corrected image data by correcting image data on the basis of correction condition data;

a step of superimposing an original image based on the image data and a corrected image based on the corrected image data onto each other and displaying either of the images on the display screen; and

a step of switching between the images in response to an input from the input means, so that either the original image or the corrected image is displayed on the display screen.

An image processing method according to a fourth aspect of the present invention comprises:

storing image data in a first storage means; and

correcting and storing the image data in a second storage means in a case where the first storage means has a predetermined capacity or more; and

compressing and storing the image data in the first storage means in a case where the first storage means has a capacity smaller than a predetermined level, until the capacity of the first storage means reaches a predetermined level or more.

### Effects of Invention

The present invention enables a user to easily confirm the degree to which original image data has been corrected.

### BRIEF DESCRIPTION OF THE DRAWINGS

FIG. 1 is a plan view of a portable information terminal, which is an embodiment of the image display apparatus of the present invention.

FIG. 2 is a block diagram of the portable information terminal of FIG. 1.

FIG. 3 is a flow chart of a photographic process.

FIG. 4 is an example of the display screen of the portable information terminal of FIG. 1.

FIG. 5 is an example of the display screen of the portable information terminal of FIG. 1.

FIG. 6 is a block diagram showing an example of image data processing.

FIG. 7 is a flow chart of a viewing process.

FIG. 8 is an example of the portable information terminal of FIG. 1 displaying a corrected image on the display.

FIG. 9 is an example of the portable information terminal of FIG. 1 displaying an original image on the display screen.

FIG. 10 is a plan view of the screen showing the process at the time that an image is viewed.

FIG. 11 is a flow chart showing a process of the present image data.

### MODE FOR CARRYING OUT THE INVENTION

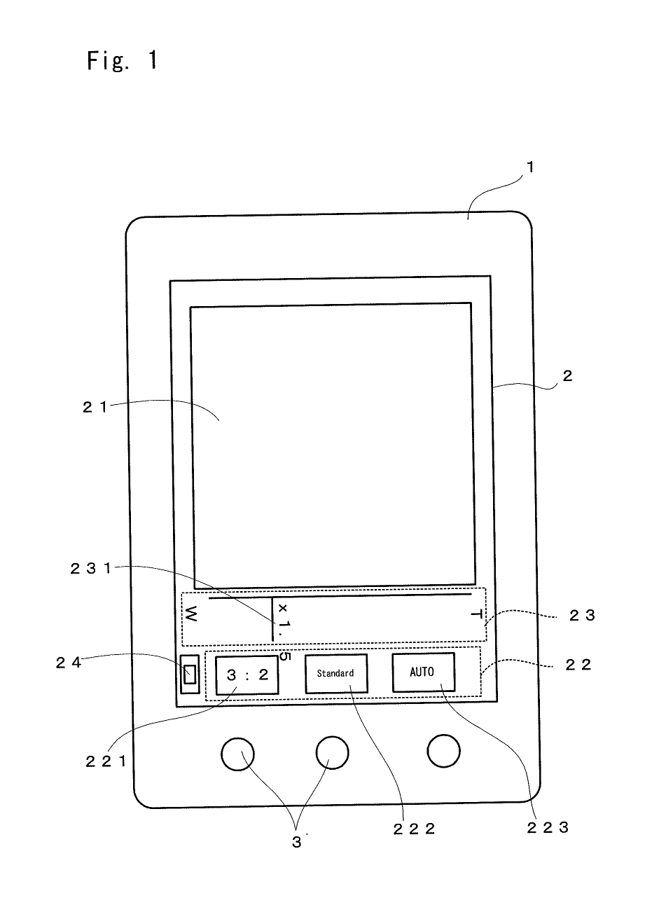

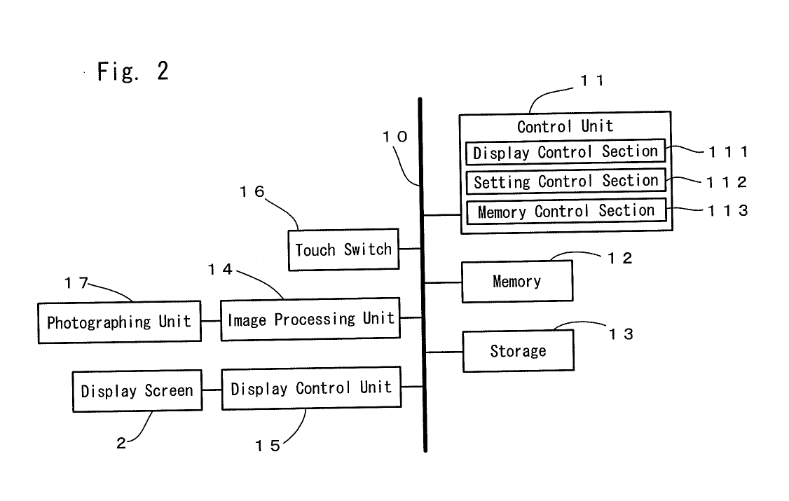

Hereinafter, the present invention is described with reference to the drawings, in accordance with one embodiment in which the image display apparatus of the present invention is applied to a portable information terminal equipped with a camera, such as a so-called smartphone. FIG. 1 is a plan view of the portable information terminal, and FIG. 2 is a block diagram of the portable information terminal of FIG. 1.

### Structure of Portable Information Terminal

As shown in FIG. 1, the portable information terminal includes a housing 1 having a rectangular shape in plan view, and on the front surface of the housing 1, a display screen 2 having a rectangular shape is provided. The display screen 2 comprises a liquid crystal display, an organic EL display, or the like. With the surface of the display screen 2, a known touch switch, such as an electrostatic capacity-type or resistive-type touch switch, is provided. Therefore, touching the display screen 2 with a finger allows the terminal to be operated. A plurality of operation buttons 3 are further located below the display screen 2, and the terminal can thus also be operated with the operation buttons 3. On the back side of the housing 1, a camera lens (not shown) is located, thereby allowing a photograph to be taken.

Next, an explanation is given with respect to a functional configuration of the above-described portable information terminal. As shown in FIG. 2, the portable information terminal includes a control unit 11, a memory 12, and storage 13, which are electrically connected to a bus 10. The bus 10 is further connected to an image processing unit 14 for processing an image photographed by a camera, a display control unit 15 for the display screen, and a touch switch 16 for inputting a signal. The control unit 11 comprises a central processing unit (CPU), and the like, and includes as functional blocks, a display control section 111 for switching between images on the display screen 2, a memory control section 113 for controlling the storage of produced image data in the memory 12 and the storage 13, and a setting control section 112 for setting the photographic conditions described below. The storage 13 is a nonvolatile storage means, such as a hard disk or a flash memory. In the storage 13, a processing program for photographing and displaying an image, photographed image data, and the like, are stored. The memory 12 functions as a temporary work area for an application program, as well as an area where image data is temporarily stored.

The image processing unit 14 is electrically connected to a photographing unit 17 for photographing an image. The photographing unit 17 includes an optical lens, an image sensor, and a flash light source. The photographing unit 17 converts light coming from the lens into an analog electrical signal using the image sensor. The image sensor may be, for example, a CCD (Charge Coupled Device) image sensor, a CMOS (Complementary Metal Oxide Semiconductor), or the like. In the image processing unit 14, an electrical signal transmitted from the photographing unit 17 is amplified, A/D converted into a digital signal, which is then converted into a format such as a bitmap to thereby produce present image data. The present image data is further subjected, in response to an instruction from the control unit 11, to a correction process, such as a transparency process, an edge enhancement process, a color reproduction process, or a brightness correction process, as required. Then, the memory control unit 113 of the control unit 11 stores the thus corrected present image data in the storage 13. In addition, the present image data is decimated, e.g., resized, to produce thumbnail image data, and the thumbnail image data is corrected to produce corrected thumbnail image data. These data are stored in the memory 12 according to an instruction from the control unit 11.

The display control unit 15 is electrically connected to the display screen 2. The display control unit 15 activates and controls the display screen 2, such as a liquid-crystal or organic-EL display, in accordance with the corrected image data to be displayed on the display screen 2 and on the basis of the control signal transmitted from the display control section 111 of the control unit 11. Thereby, an image based on various image data transmitted via the display control unit 15 appears on the display screen 2. In the display screen 2, a plurality of images can be superimposed onto one another. For example, when two images, i.e., a first image and a second image, are superimposed onto each other, and when the first image is subjected to a transparency process and the second image is placed thereover, only the second image can be visually recognized. On the other hand, when the second image is subjected to the transparency process, the first image can be visually recognized.

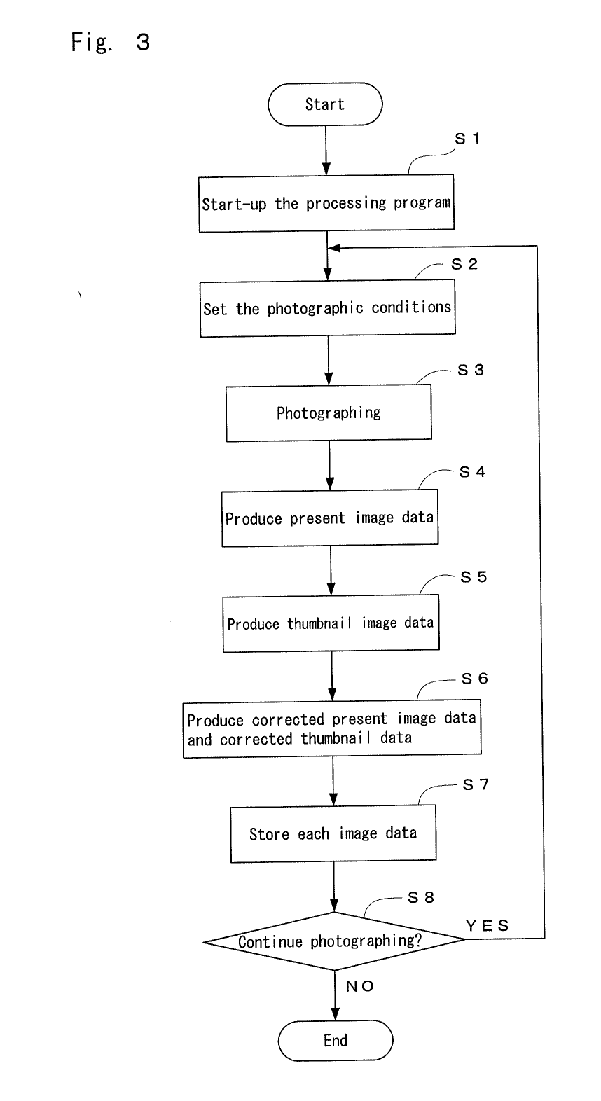

Hereinafter, an explanation is given with respect to a photographic method using the portable information terminal configured as described above. First, the control unit 11 of the portable information terminal loads the processing program stored in the storage 13 into the memory 12 to execute the program. Thereby, photographing can be performed, and the viewing process described below can be executed. Hereinafter, the execution of the processes is described with reference to the flow chart of FIG. 3.

### Photographic Process

When a processing program is started (S1), an initial screen appears on the display screen 2, as shown in FIG. 1. The initial screen includes three areas, i.e., a display area 21 having a rectangular shape extending from the upper portion of the screen through the center thereof, a photographic condition area 22 at the lower portion of the screen, and a zoom display area 23 located between the above-mentioned two areas. At the left end portion of the initial screen, a view switch icon 24 for switching to a screen for viewing photographed images is provided. The display area 21 functions as a finder for displaying an image photographed with a camera. The photographic condition area 22 displays icons 221, 222, and 223 representing three types of photographic conditions, i.e., an image aspect ratio, image correction content suitable for the photographic situation, and the presence or absence of a flash. In the icons 221, 222, and 223 for photographic modes, currently selected conditions are respectively indicated.

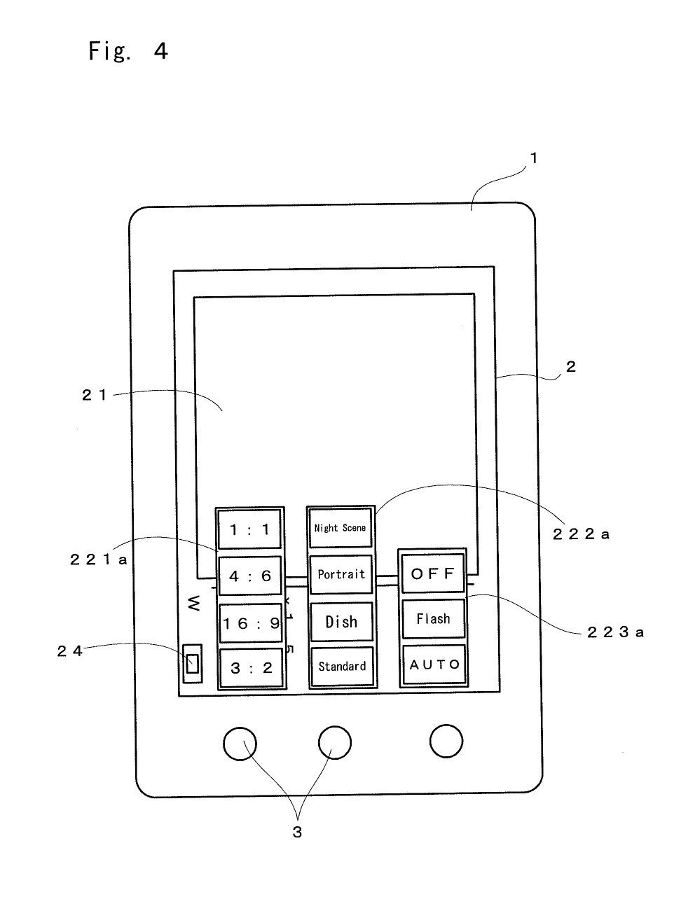

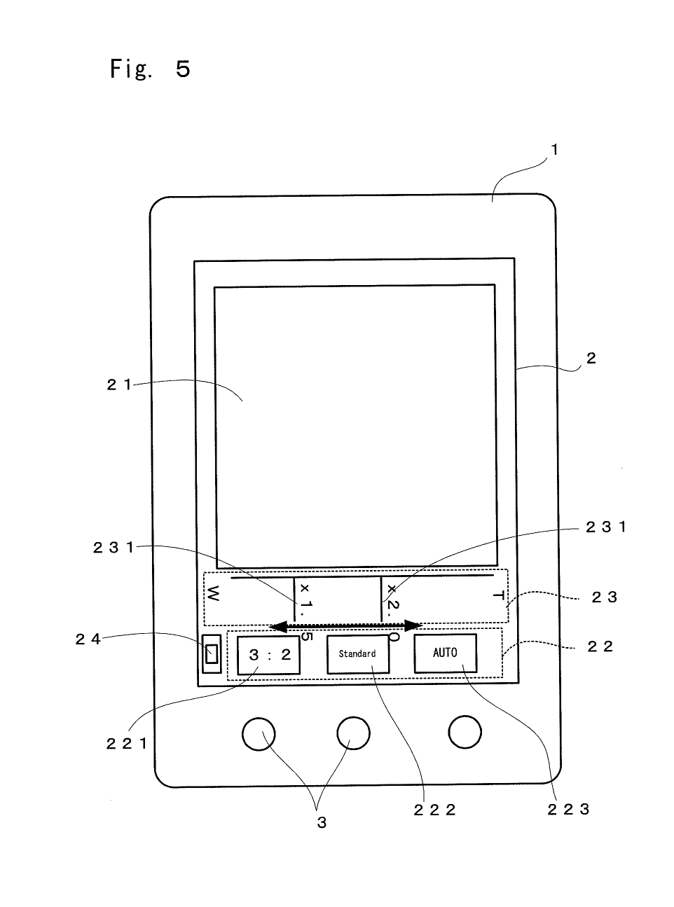

More specifically, when the icons representing the photographic conditions are tapped, pop-up displays 221a, 222a, and 223a, each containing listed icons for selecting the condition, appear as shown in FIG. 4. In this state, when one of the icons is tapped, the pop-up displays 221a, 222a, and 223a are closed, and the selected conditions are displayed on the photographic condition area 22 as icons. For example, the aspect ratio is to be selected from prepared aspect ratios of 1:1, 3:2, 4:6, and 16:9. The image correction content refers to conditions for correcting original image data according to the photographic target so that an optimum image is produced. In this embodiment, there are four conditions, i.e., “standard” in which no correction is made, “night scene” for photographing a night scene, “portrait” for photographing a person's face, and “dish” for photographing food. Regarding the presence or absence of a flash, there are three conditions, i.e., “OFF” in which no flash is generated, “Flash” in which a flash is forced to be generated, and “AUTO” in which the necessity of a flash is automatically determined. For convenience in explanation, all the pop-up displays 221a, 222a, and 223a for selecting the photographic modes are shown in FIG. 4. Actually, however, one pop-up display appears at a time so as to allow each of the photographic conditions to be respectively selected. As shown in FIG. 1, in the zoom display area 23, an icon 231 indicating the current zoom magnification is provided. FIG. 5 shows a case where this icon is dragged with a finger; specifically, dragging the icon 231 to the left side of the figure decreases the magnification, whereas dragging the icon 231 to the right side increases the magnification. As the icon 231 is dragged, the value indicating the magnification level displayed on the icon 231 is changed accordingly.

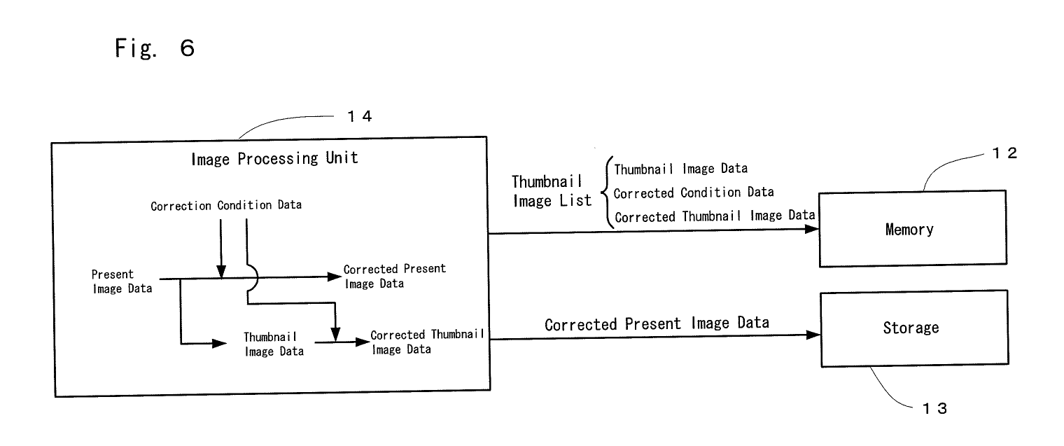

Referring back to FIG. 3, the explanation of the photographic process is continued. When the initial screen is displayed as described above, the three photographic conditions, i.e., image correction, zoom magnification, and presence or absence of a flash, are set in accordance with the procedure described above (S2). Then, signals representing the zoom magnification and the presence or absence of a flash are transmitted from the control unit 11 to the photographing unit 17. Regarding the image correction, the control unit 11 transmits the correction condition data containing correction parameters from the memory 12 to the image processing unit 14, allowing the image correction conditions to be set. Such photographic condition setting is performed by the setting control section 112 of the control unit 11. Subsequently, a camera lens on the back of the portable terminal is directed toward a photographic object, and an operation button 3 is pressed to perform photographing (S3). As described earlier, the electrical signal generated by the photographing unit 17 is A/D converted, and then present image data converted into a bitmap format is produced (S4). Hereinafter, an explanation is given with reference also to FIG. 6. The present image data produced in the above manner is decimated to produce thumbnail image data (S5). The present image data and the thumbnail image data are further subjected to a correction process in the image processing unit 14. Specifically, each image data is subjected to a correction process based on the correction condition data previously instructed from the control unit 11 to thereby produce corrected present image data. For example, a process suitable for the selected correction content, such as an edge enhancement process, a color reproduction process, or a brightness correction process, is performed. As such, due to the correction processes, the corrected present image data is produced from the present image data, while corrected thumbnail image data is produced from thumbnail image data (S6). Thereafter, the corrected present image data is stored in the storage 13, while thumbnail image data, correction condition data, and corrected thumbnail image data are stored in the memory 12 as a group for an image list (S7). At this time, the image list may contain only the thumbnail image data and the correction condition data, and corrected thumbnail image data can thereafter be produced on the basis of the correction condition data. Then, if photographing is continued (YES of S8), back in Step S2, photographic conditions are set. When photographing is not continued (NO of S8), the photographic process is terminated. In this way, when photographing is continuously performed, image data, etc., are stored in the memory 12 and the storage 13, in the photographed order. As explained below, the image data, etc., stored in the memory 12 are used to be viewed in the processing program, while the corrected image data stored in the storage 13 is used for storage, and to be viewed by using, for example, a viewing software preliminarily installed in the portable terminal.

### Viewing Process

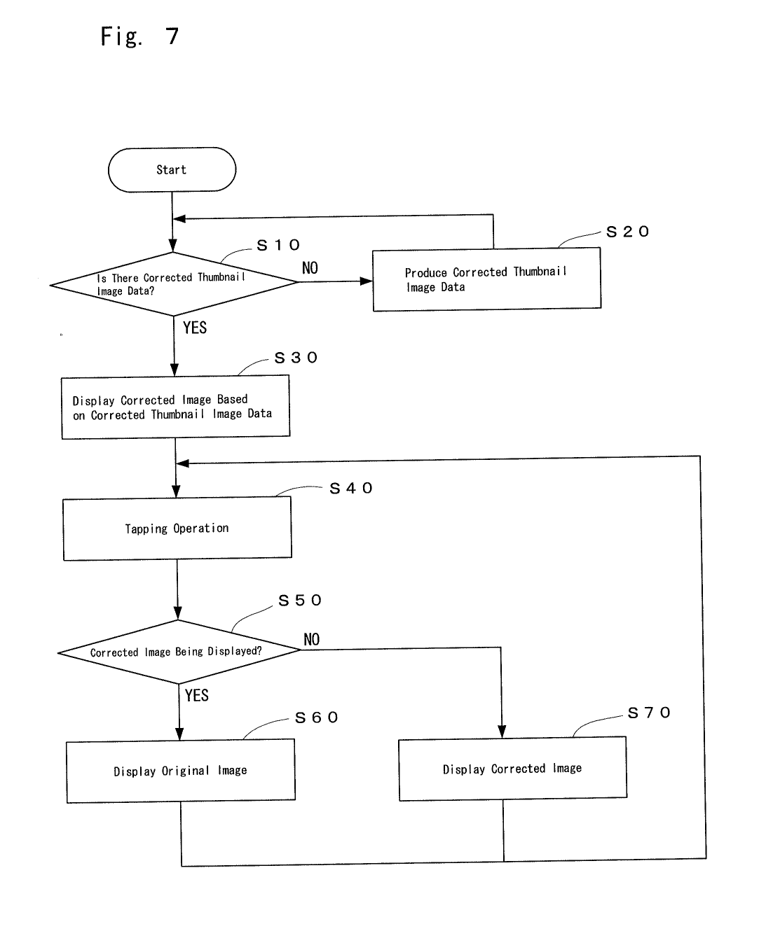

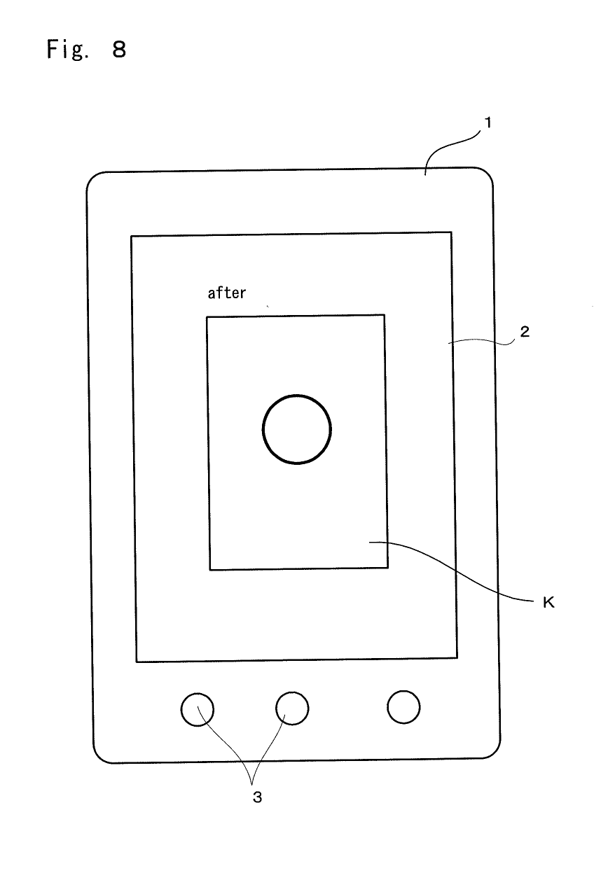

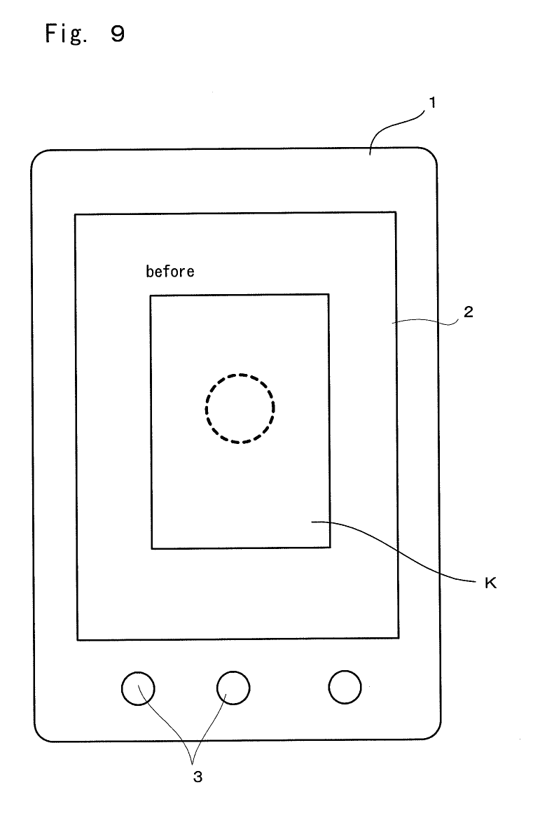

Hereinafter, a method for viewing photographed thumbnail image data and corrected thumbnail image data is described with reference to the flow chart of FIG. 7. First, when the view switch icon 24 on the initial screen of FIG. 1 is tapped, the memory control section 112 of the control unit 11 confirms whether the image list stored in the memory 12 contains corrected thumbnail image data (S10). If no corrected thumbnail image data exists (NO of S10), the thumbnail image data is corrected in the image processing unit 14 on the basis of the correction condition data (S20). This allows one image list to contain thumbnail image data, correction condition data, and corrected thumbnail image data. If the image list contains corrected thumbnail image data (YES of S10), the control unit 11 displays a corrected image based on corrected thumbnail image data on the display screen 2, as shown in FIG. 8 (S30). At this time, the original image based on the thumbnail image data and the corrected image are displayed on the display screen 2 in an overlapping manner. Subjecting the original image to a transparency process allows only the corrected image to be displayed. In this state, when the corrected image being displayed is tapped (S40), the control unit 11 distinguishes whether the image currently displayed is an original or corrected image (S50). When the image is a corrected image, (YES of S50), the transparency-processed original image becomes unprocessed, thereby allowing the original image to appear on the screen as shown in FIG. 9, while the corrected image currently displayed undergoes a transparency process and disappears from the screen (S60). The display control section 111 of the control unit 11 shows an indication of the word “after” on the display screen 2 as shown in FIG. 8, by which the image is visually confirmed as a corrected image. In contrast, the control unit 11 shows an indication of the word “before” on the display screen 2 as shown in FIG. 9, by which the image is visually confirmed as an original image. These indications are replaced with one another upon instruction from the control unit 11 at the same time that the images are switched therebetween. Then, the display screen 2 is tapped (S40), and if an original image is being displayed on the display screen 2 (NO of S50), the image being displayed on the display screen 2 is switched to a corrected image (S70).

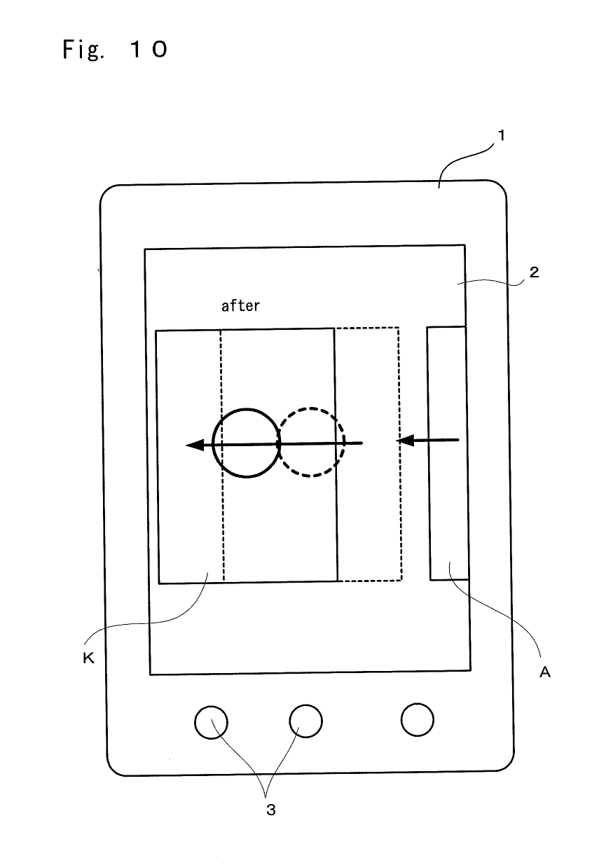

When there is a plurality of image lists, the original image and corrected image in each list can be viewed as described above. In addition, when there is a plurality of image lists, and when the display screen 2 is flicked in the state that an image K is displayed as shown in FIG. 10, the other image A is displayed on the screen.

As described above, according to the present embodiment, the memory 12 stores an image list containing thumbnail image data, correction condition data, and corrected thumbnail image data. Further, an original image and a corrected image produced therefrom are superimposed onto each other, and either of the images is displayed on the display screen 2. Then, tapping the display screen 2 switches between the images displayed on the screen so that either the original or corrected image is displayed on the display screen 2. This allows a user to easily visually confirm the effect of correction. In particular, since an original image and a corrected image are arranged in an overlapping manner, the difference between the images can easily be confirmed.

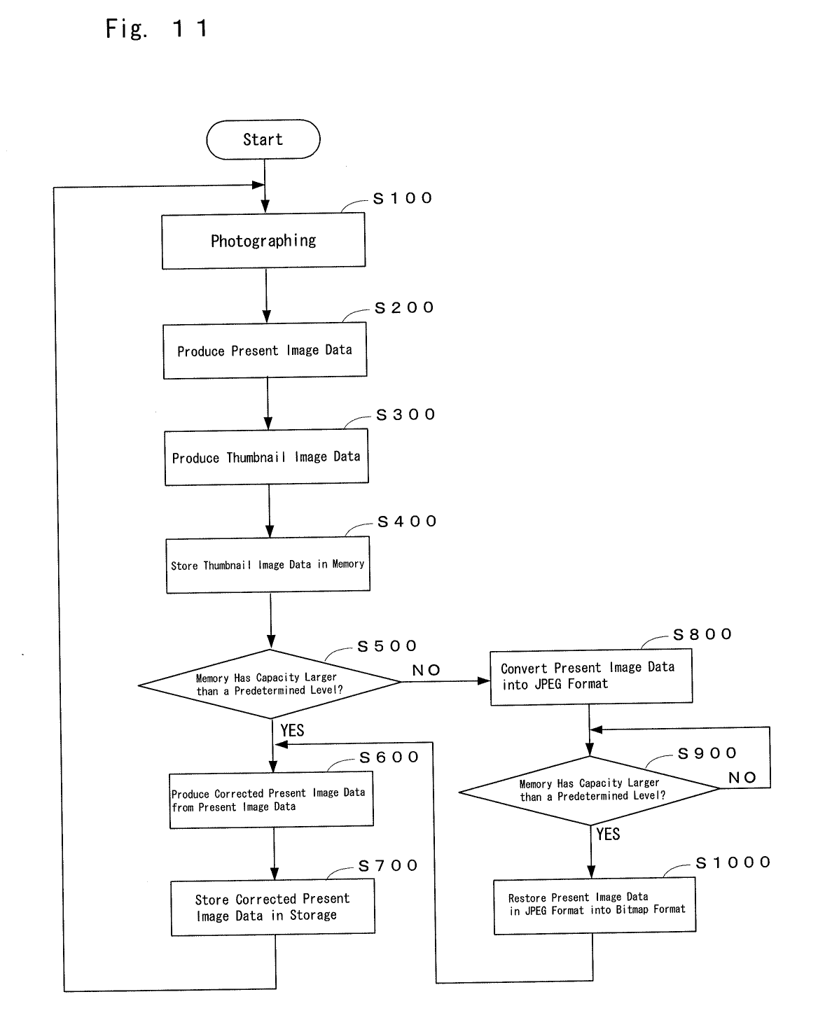

If photographing is performed continuously, the volume of the image data stored in the memory 12 increases, possibly interfering with the execution of the program, such as the correction process. This poses a particular problem in a smartphone because the memory 12 of a smartphone has a small capacity. Therefore, the following process can be performed depending on the capacity of the memory. This process is described below with reference to the flow chart of FIG. 11.

When photographing is performed (S100), the electrical signal generated by the photographing unit 17 is A/D converted, and then, present image data in bitmap format is produced (S200). The present image data produced in the above manner is decimated to produce thumbnail image data (S300). The produced thumbnail image data is stored in the memory 12 (S400). Here, the control unit 11 identifies the capacity of the memory 12. If the capacity is equal to a predetermined level or more (YES of S500), the present image data is corrected to obtain corrected image data (S600). The corrected image data is stored in the storage 13 (S700). If the capacity of the memory is less than a predetermined level (NO of S500), the present image data is converted and compressed into JPEG format, and enters a waiting state (S800). Then, the capacity of the memory 12 is identified again. If the capacity is equal to a predetermined level or more (YES of S900), the present image data is restored to bitmap format (S1000). Thereafter, back in step 5600, a correction process is performed. If the capacity of the memory 12 is less than a predetermined level (NO of S900), the present image data is stored as is in JPEG format until the memory 12 is released. As such, after the present image data is corrected and stored in the storage 13, back in Step 5100, photographing is performed again.

According to the above-described process, a large volume of the present image data is stored in JPEG format, which maintains it in a smaller volume thereof, until the memory 12 is released. This allows other processes in the memory 12 to be smoothly accomplished.

The above describes an embodiment of the present invention. However, the present invention is not limited to this embodiment, and various modifications may be made therein without departing from the spirit of the invention. For example, although in the above-described embodiment, the images are operated using a touch switch, the present invention is not limited thereto, and an operation button or the like may be used to switch between an original image and a corrected image. In the above-described embodiment, an original image and a corrected image are produced from thumbnail image data, and a user can confirm the difference between the original and corrected images on the display screen. However, the same process can also be performed using present image data and corrected present image data. The present image data may be in a known format, other than bitmap. The compressed format may also be in a known format, other than JPEG.

The above-described embodiment shows an example where the image display apparatus of the present invention is applied to a portable information terminal with a camera. However, the image display apparatus of the present invention is also applicable to a device with no camera, such as a personal computer. In such a case, image data photographed outside the device may be used and viewed by applying the above-described method and processing program.

### EXPLANATION OF REFERENCE NUMERALS

11 Control Unit (Control Means)
12 Memory (First Storage Means)
13 Storage (Second Storage Means)
14 Image Processing Unit (Image Processing Means)
15 Display Control Section (Display Means)
16 Touch Switch (Input Means)
17 Photographing Unit (Photographing Means)
2 Display Screen
3 Operation Button (Input Means)

1. An image display apparatus comprising:
a first storage means for storing at least one item of image data, correction condition data for correcting the image data, and corrected image data obtained after the image data is corrected on the basis of the correction condition data;
an image processing means for producing the corrected image data by correcting the image data on the basis of the correction condition data;
a display means comprising a screen for superimposing an original image based on the image data and a corrected image based on the corrected image data onto each other and displaying either the original image or the corrected image;
an input means for selecting an image to be displayed on the display screen; and
a display control means for switching between the images in response to an input from the input means, so that either the original image or the corrected image is displayed on the display screen.

2. The image display apparatus according to claim 1, further comprising:
an image-capturing means for producing the image data;
a setting control means for selecting one correction condition from a plurality of correction conditions before the image-capturing means captures an image and specifying the correction condition data associated with the correction condition; and
a storage control means for storing in the first storage means the image data produced by the image-capturing means, the specified correction condition data, and the corrected image data produced by the image processing means.

3. The image display apparatus according to claim 2, further comprising a nonvolatile second storage means for storing the corrected image data,
wherein the storage control means allows the second storage means to store the corrected image data produced by the image processing means.

4. The image display apparatus according to claim 1, wherein the input means comprises a touch switch provided with the display screen, and wherein touching the touch switch switches between the original image and the corrected image displayed on the display screen.

5. The image display apparatus according to claim 1, wherein the display control means displays an indication specifying an image before correction when the original image is displayed on the display screen, and displays an indication specifying an image after correction when the corrected image appears on the display screen.

6. A method for displaying an image using an image display apparatus including a screen for displaying an image and an input means for selecting an image to be displayed on the display screen, the method comprising:
an image-processing step of producing corrected image data by correcting image data on the basis of correction condition data;
a displaying step of superimposing an original image based on the image data and a corrected image based on the corrected image data onto each other and displaying either the original image or the corrected image on the display screen; and
a switching step of switching between the images in response to an input from the input means, so that either the original image or the corrected image is displayed on the display screen.

7. An image display program for causing a computer within an image display apparatus including a display screen for displaying an image and an input means for selecting an image to be displayed on the display screen, to execute:
an image-processing step of producing corrected image data by correcting image data on the basis of correction condition data;
a step of superimposing an original image based on the image data and a corrected image based on the corrected image data onto each other and displaying either of the images on the display screen; and
a step of switching between the images in response to an input from the input means, so that either the original image or the corrected image is displayed on the display screen.

8. The image display apparatus according to claim 2, wherein the input means comprises a touch switch provided with the display screen, and wherein touching the touch switch switches between the original image and the corrected image displayed on the display screen.

9. The image display apparatus according to claim 3, wherein the input means comprises a touch switch provided with the display screen, and wherein touching the touch switch switches between the original image and the corrected image displayed on the display screen.

10. The image display apparatus according to claim 2, wherein the display control means displays an indication specifying an image before correction when the original image is displayed on the display screen, and displays an indication specifying an image after correction when the corrected image appears on the display screen.

11. The image display apparatus according to claim 3, wherein the display control means displays an indication specifying an image before correction when the original image is displayed on the display screen, and displays an indication specifying an image after correction when the corrected image appears on the display screen.

12. The image display apparatus according to claim 4, wherein the display control means displays an indication specifying an image before correction when the original image is displayed on the display screen, and displays an indication specifying an image after correction when the corrected image appears on the display screen.

13. The image display apparatus according to claim 8, wherein the display control means displays an indication specifying an image before correction when the original image is displayed on the display screen, and displays an indication specifying an image after correction when the corrected image appears on the display screen.

14. The image display apparatus according to claim 9, wherein the display control means displays an indication specifying an image before correction when the original image is displayed on the display screen, and displays an indication specifying an image after correction when the corrected image appears on the display screen.
